(19) United States
(12) Patent Application Publication
(10) Pub. No.: US 2013/0325607 A1
(43) Pub. Date: Dec. 5, 2013

(54) MOBILE-2-WEB RETARGETING

(71) Applicant: AIRPUSH, INC., Los Angeles, CA (US)

(72) Inventor: Asher Delug, Los Angeles, CA (US)

(73) Assignee: Airpush, Inc., Los Angeles, CA (US)

(21) Appl. No.: 13/827,350

(22) Filed: Mar. 14, 2013

Related U.S. Application Data
(63) Continuation-in-part of application No. 13/623,844, filed on Sep. 20, 2012.
(60) Provisional application No. 61/654,703, filed on Jun. 1, 2012.
(60) Provisional application No. 61/654,802, filed on Jun. 1, 2012.
(60) Provisional application No. 61/672,939, filed on Jul. 18, 2012.
(60) Provisional application No. 61/698,449, filed on Sep. 7, 2012.
(60) Provisional application No. 61/760,952, filed on Feb. 5, 2013.

(51) Int. Cl. G06Q 30/02

(52) U.S. Cl. CPC G06Q 30/0269
USPC 705/14.53

(57) ABSTRACT

Among other disclosed subject matter, a computer-implemented method for providing audience targeting for advertisements is disclosed. The method includes receiving a bid request to display an advertisement to a user in an advertising section of a webpage, where the bid request includes an internet protocol (“IP”) address associated with the user. The method includes identifying a user profile associated with the user, where the identified user profile includes at least one IP address that matches the IP address included in the bid request. The method includes determining an advertisement to display to the user, the determination based at least in part on a user preference included in the user profile.

### CLAIM OF PRIORITY

This application is a continuation-in-part to U.S. Nonprovisional application Ser. No. 13/623,844 filed Sep. 20, 2012, which claims priority to U.S. Provisional Application Nos. 61/654,703, filed Jun. 1, 2012, 61/654,802 filed Jun. 1, 2012, 61/672,939, filed Jul. 18, 2012, 61/698,449, filed Sep. 7, 2012, 61/713, 421, filed Oct. 12, 2012, 61/760,952, filed Feb. 5, 2013, and which are hereby incorporated by reference in their entireties.

### FIELD

Various embodiments of the disclosed facility generally relate to providing services and information to an internet user.

### BACKGROUND

Currently, uninvited ads such as email spam, pop-up ads and plug-in ads are being gradually phased out because of their unpopularity among users. On the other hand, because of their ability to personalize advertising based on the audience, targeted advertisements are becoming a major trend for current online advertisements.

“Targeted” refers to the filtering of an audience. With targeted advertisement, the advertisement to be displayed to a user depends on the user. Various targeting schemes are currently being used. Using targeted advertising, one may select different advertisements to display to a user based on such factors as date, time, possible gender, etc. of the user. For instance, the targeted advertising may display advertisements of different business natures based on different times in a day or a week. The goal is to improve the efficiency of online advertising to the audience with targeted ads. Existing methods of targeted advertising mainly have search-based advertising. Search-based advertising is a type of ad search based on searching for targeted ads that match a keyword. After a user enters search information, an advertising web server finds all types of advertisements that match the keyword(s) entered by the user and displays these advertisements to the user. Although existing technologies can provide user-related online advertisements to a certain extent, the advertising schemes do not consider the conditions of each individual user and hence cannot provide each individual user online advertisements that meet the user's preferences and fit the user's identity.

Among teaching a variety of other things, certain aspects of the inventions herein have embodiments which may satisfy one or more of the above-described issues.

### SUMMARY OF THE DESCRIPTION

The present invention relates to methods and systems for determining a dynamic array of services and information (e.g., online advertisements), to provide an internet user. In a first aspect, a computer-implemented method for providing audience targeting for advertisements is disclosed. The method includes receiving a bid request to display an advertisement to a user in an advertising section of a webpage, the bid request including an internet protocol (“IF”) address associated with the user. The method includes identifying a user profile associated with the user, where the identified user profile includes at least one IP address that matches the IP address included in the bid request. The method includes determining an advertisement to display to the user, the determination based at least in part on a user preference included in the user profile.

Implementations can include any, all, or none of the following features. The method can further include, where the user profile associated with the user is gathered from a computing device associated with the user. The step of gathering the user profile includes determining an IP address included in a communication from the computing device and storing the determined IP address in the user profile. The method further includes, where a given IP address is stored in a given user profile only if the given IP address belongs to a specific class of IP addresses. The method further includes, where the specific class of IP addresses includes the private IP address class. The method further includes, where a plurality of computing devices are associated with the user, each of the plurality of computing devices communicating at least once utilizing the IP address.

In addition, the step of gathering the user profile in the method further includes determining information associated with one or more applications installed on the computing device of the user, where the determined information includes one or more of a name, category, or a manufacturer associated with the one or more applications. The step of gathering the user profile in the method further includes determining a usage pattern associated with the user's selection of the one or more applications over a period of time, and determining a user preference based at least in part on the determined usage pattern associated with the one or more applications. The step of gathering the user profile in the method further includes storing the determined user preference, the usage pattern and the information associated with the one or more applications in the user profile.

The method further includes, where the identified one or more applications includes an application installed in a given location of the computing device of the user, the given location including one or more of a desktop location of the user's computing device, the entire user's computing device, a favorites folder location in the user's computing device, or a location maintaining a list of frequently executed applications. The method further includes determining, by the advertising server, a bid amount to include in a bid response, where the bid amount is the maximum amount offered for the display of the advertisement in the advertising section of the webpage. The method further includes generating, by the advertising server, the bid response for the display of the advertisement, the bid response including the bid amount and an indicator associated with the advertisement. Here, the bid request includes at least one of an indicator associated with the advertising section of the webpage, the model name of a computing device utilized to display the advertisement, the name of an operating system running on the computing device, the name of the webpage, the universal device identification number associated with the computing device, or the name of a provider of internet services to the computing device.

In a second aspect, a computer-implemented method for providing audience targeting for advertisements is disclosed. The method includes accessing a webpage by a user through a computing device, where the webpage includes an advertising section for display of a given advertisement in the webpage. The method includes sending information for a bid request for display of an advertisement in the advertising section of the webpage, the information is sent as a communication over a network, where the communication includes an internet protocol (“IP”) address associated with the computing device. The method includes receiving the advertisement to display to the user in the advertising section of the webpage, the received advertisement determined at least in part based on a user preference included in the user profile, where the user profile is associated with the user. Here, the user profile of the user includes at least one IP address that matches the IP address included in the communication. Implementations can include any, all, or none of the following features. The method can further include, where the user profile associated with the user is gathered from a second computing device associated with the user. The step of gathering the user profile includes determining a second IP address included in a second communication from the second computing device and storing the second determined IP address in the user profile.

In a third aspect, a system for providing audience targeting for advertisements is disclosed. The system includes at least one memory-storing computer-executable instructions. The system includes at least one processor configured to access the at least one memory and execute the computer-executable instructions to perform a set of acts. Here, the set of acts includes (1) receiving a bid request to display an advertisement to a user in an advertising section of a webpage, the bid request including an internet protocol (“IP”) address associated with the user; (2) identifying a user profile associated with the user, where the identified user profile includes at least one IP address that matches the IP address included in the bid request; and (3) determining an advertisement to display to the user, the determination based at least in part on a user preference included in the user profile.

Implementations can include any, all, or none of the following features. Other advantages and features will become apparent from the following description and claims. It should be understood that the description and specific examples are intended for purposes of illustration only and are not intended to limit the scope of the present disclosure.

### BRIEF DESCRIPTION OF THE DRAWINGS

These and other objects, features, and characteristics of the present invention will become more apparent to those skilled in the art from a study of the following detailed description in conjunction with the appended claims and drawings, all of which form a part of this specification. In the drawings:

FIG. 1 and the following discussion provide a brief, general description of a representative environment in which the invention can be implemented;

FIG. 2 illustrates a mobile device and a user profile gathered for the user of the mobile device based on information from the mobile device;

FIG. 3 illustrates advertisement targeting in a mobile device based on the gathered user profile;

FIG. 4 provides an illustrative example of how a publisher's ad inventory is received and marketed by the RTB Exchange 420 to potential advertisers;

FIG. 5 provides an illustrative example of how a web user is identified by the ad platform through the information provided by the RTB Exchange in the bid requests and how advertisement targeting is performed if a gathered user profile is available for the web user;

FIG. 6 is a flow chart illustrating user profile gathering (discussed in conjunction with FIG. 2) that is used in “hyper-targeting” techniques;

FIG. 7 is a flow chart illustrating how the information included in a bid request from an RTB Exchange could be used to identify the user profile of an internet user and use the identified user profile to provide targeted advertisements to the internet user; and

FIG. 8 is a high-level block diagram showing an example of the architecture for a computer system.

The headings provided herein are for convenience only and do not necessarily affect the scope or meaning of the claimed invention.

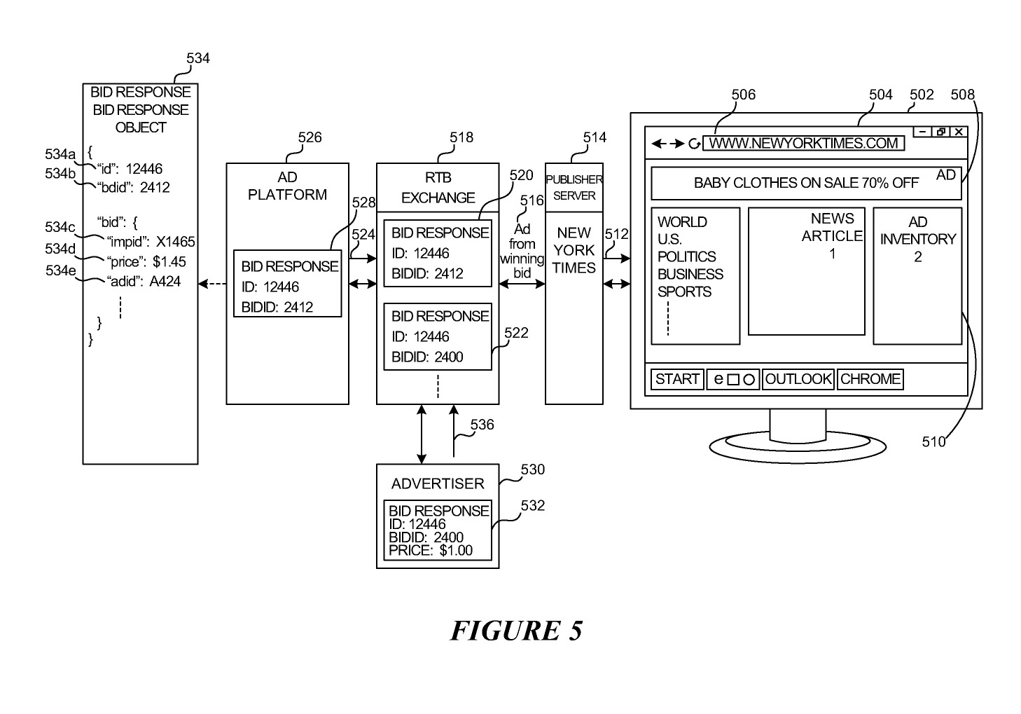

In the drawings, the same reference numbers and any acronyms identify elements or acts with the same or similar structure or functionality for ease of understanding and convenience. To easily identify the discussion of any particular element or act, the most significant digit or digits in a reference number refer to the Figure number in which that element is first introduced (e.g., element 504 is first introduced and discussed with respect to FIG. 5).

### DETAILED DESCRIPTION

Various examples of the invention will now be described. The following description provides specific details for a thorough understanding and enabling description of these examples. One skilled in the relevant art will understand, however, that the invention may be practiced without many of these details. Likewise, one skilled in the relevant art will also understand that the invention can include many other obvious features not described in detail herein. Additionally, some well-known structures or functions may not be shown or described in detail below, so as to avoid unnecessarily obscuring the relevant description.

The terminology used below is to be interpreted in its broadest reasonable manner, even though it is being used in conjunction with a detailed description of certain specific examples of the invention. Indeed, certain terms may even be emphasized below; however, any terminology intended to be interpreted in any restricted manner will be overtly and specifically defined as such in this Detailed Description section. Note that references in this specification to “an embodiment,” “one embodiment,” or the like mean that the particular feature, structure, or characteristic being described is included in at least one embodiment of the present invention. Occurrences of such phrases in this specification do not necessarily all refer to the same embodiment.

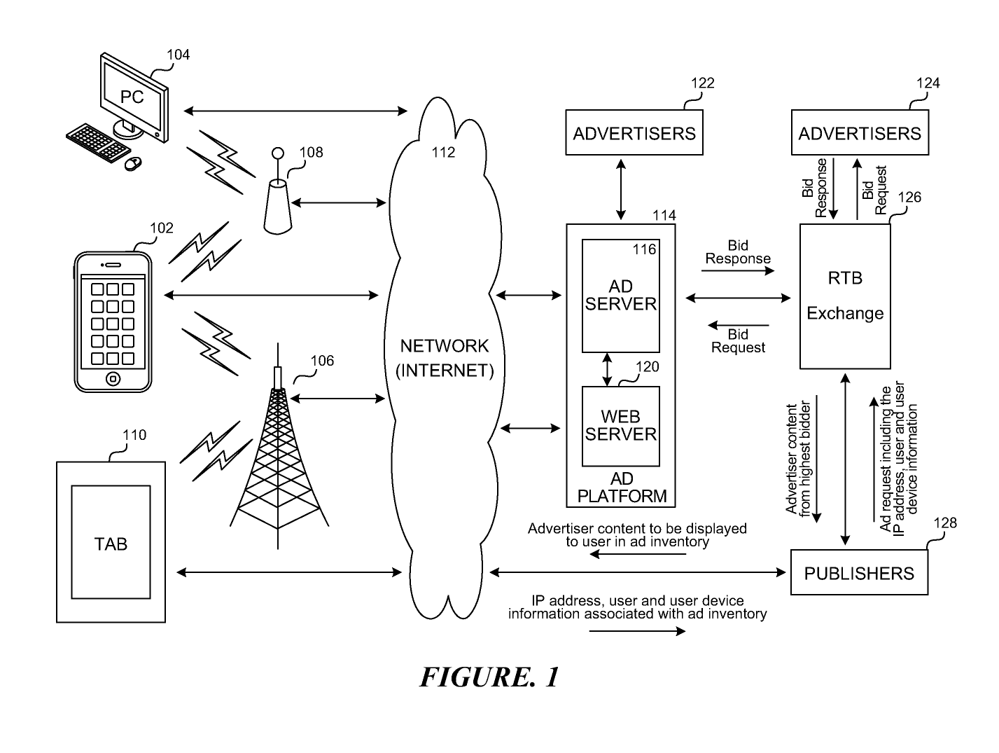

FIG. 1 and the following discussion provide a brief, general description of a representative environment in which the invention can be implemented. Although not required, aspects of the invention may be described below in the general context of computer-executable instructions, such as routines executed by a general-purpose data processing device (e.g., a server computer or a personal computer). Those skilled in the relevant art will appreciate that the invention can be practiced with other communications, data processing, or computer system configurations, including: wireless devices, Internet appliances, hand-held devices (including personal digital assistants (PDAs)), wearable computers, all manner of cellular or mobile phones, multi-processor systems, microprocessor-based or programmable consumer electronics, set-top boxes, network PCs, mini-computers, mainframe computers, and the like. Indeed, the terms “computer,” “server,” and the like are used interchangeably herein, and may refer to any of the above devices and systems.

While aspects of the invention, such as certain functions, are described as being performed exclusively on a single device, the invention can also be practiced in distributed environments where functions or modules are shared among disparate processing devices. The disparate processing devices are linked through a communications network, such as a Local Area Network (LAN), Wide Area Network (WAN), or the Internet. In a distributed computing environment, program modules may be located in both local and remote memory storage devices.

Aspects of the invention may be stored or distributed on tangible computer-readable media, including magnetically or optically readable computer discs, hard-wired or preprogrammed chips (e.g., EEPROM semiconductor chips), nanotechnology memory, biological memory, or other data storage media. Alternatively, computer-implemented instructions, data structures, screen displays, and other data related to the invention may be distributed over the Internet or over other networks (including wireless networks) on a propagated signal on a propagation medium (e.g., an electromagnetic wave(s), a sound wave, etc.) over a period of time. In some implementations, the data may be provided on any analog or digital network (packet switched, circuit switched, or other scheme).

As shown in FIG. 1, a user may use a personal computing device (e.g., a mobile device 102, a personal computer 104, a tablet 110, etc.) to communicate with a network. The term “mobile device,” as used herein, may be a cell phone, a personal digital assistant (PDA), a portable email device (e.g., a Blackberry®), or any other device having communication capability to connect to the network using cellular services. In one example, the mobile device 102 connects using one or more cellular transceivers or base station antennas 106 (in cellular implementations), access points, terminal adapters, routers, modems or Wireless Fidelity (WiFi) access point 108 (in IP-based telecommunications implementations), or combinations of the foregoing (in converged network embodiments). WiFi access points are part of a WiFi network, which operate according to Institute of Electrical and Electronic Engineers (IEEE) 802.11 standard. These WiFi networks are generally private LAN networks, such as those networks found in a home or a small office, and typically have an indoor range of one hundred and fifty to three hundred feet, with performance likely to degrade as the distance increases.

In some instances, the network 112 is the Internet, allowing the mobile device 102, the tablet 110 (with, for example, WiFi capability) or the personal computer 104 to access web content offered through various web servers. As discussed above, a user may connect her personal computing devices, such as personal computer 104, tablet 110, or mobile device 102, which access Internet through WiFi access points utilizing protocols such as the TCP/IP protocol. Each such personal computing device is typically assigned an Internet Protocol Address (“IP address”) that identifies the device. An IP address is a unique number that may be assigned to a single device, or is shared by multiple personal computing devices of the user (where the multiple personal computing devices connect to the Internet through a shared IP-enabled router), and provides the ability to route data over a network to and from a specific device.

Internet standards governing bodies such as the American Registry for Internet Numbers (“ARIN”) provide blocks of IP addresses to Internet service providers. The Internet service provider would typically assign one of the IP addresses from its blocks of IP addresses for the user's Internet service. So, when the user interacts with the webpages available on the Internet through the provided Internet service, the user's requests using any of her personal computing devices to a website provider would include the assigned IP address.

In one instance, a user may interact with an advertisement platform 114 (which includes an advertisement server 116 and a web server 120) through the Internet 112. The advertisement platform 114 (also referred to as the “ad platform”) may then gather the IP address included in the user's interaction and store the IP address as part of the user's profile to help identify the user in future interactions. Further, when possible, the ad platform 114 may gather a unique identification number (such as the Media Access Control (“MAC”) address of a personal computer or International Mobile Station Equipment Identity (“IMEI”) of a mobile device) associated with the computing device used by the user to interact with the ad platform 114 and store the computing device's unique identification number as part of the user's profile. In this manner, the ad platform 114 may be able to associate additional IP addresses with a given user's profile when the user's interaction originates from the other IP but the same computing device (identified based on the computing device's unique identification number).

In some embodiments, the ad platform 114 may filter the IP addresses and only store those IP addresses that are associated with specific classes of IP addresses in the user's profile. For example, the ad platform 114 may store only those IP addresses that fall within the private network address space (i.e. IP addresses that fall within 10.0.0.0-10.255.255.255, 172.16.0.0-172.31.255.255, 192.168.0.0-192.168.255.255), which includes the small and private LAN networks (such as a home or a small office network). Such filtering allows the ad platform 114 to store only those IP addresses that are generally assigned to the same user over a given period of time and avoid those IP addresses (such as those provided by cellular service providers as part of their data service) that not only dynamically change as a user travels (with their personal computing device, such as a mobile device) but also gets reassigned to other users.

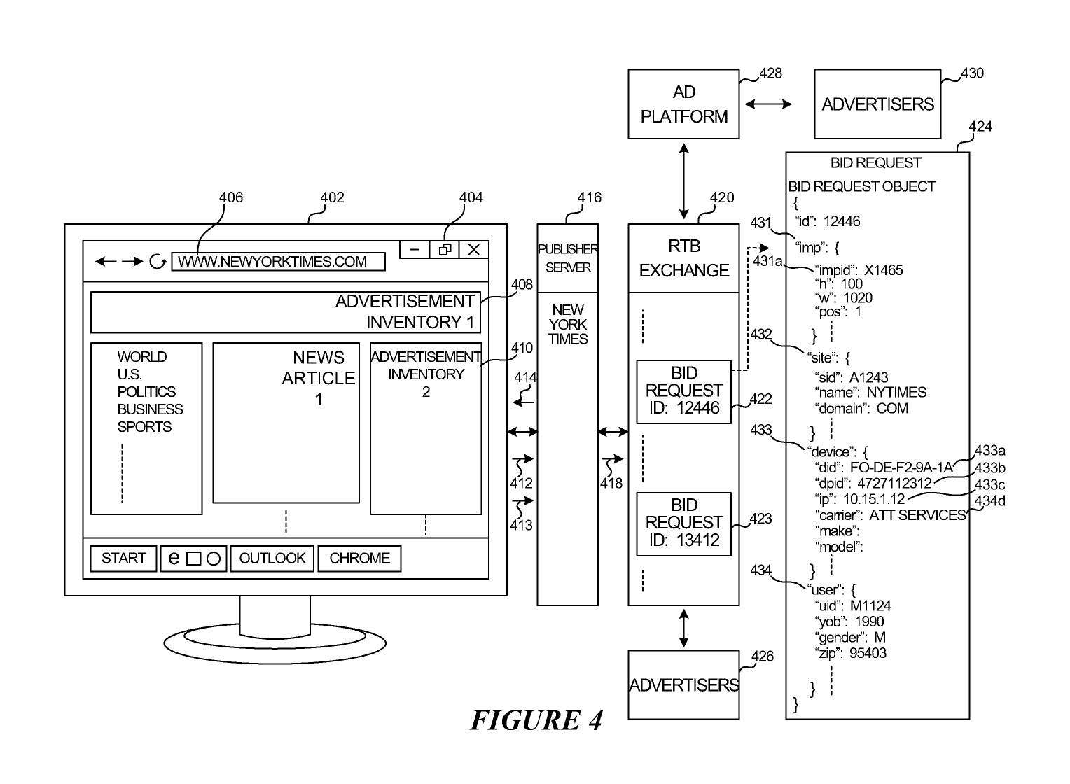

The ad platform 114 may then utilize the user's profile that includes the various IP addresses to associate various personal computing devices as possibly all belonging to the same user when the various personal computing devices interact with a website or the ad platform 114 using one of the various IP addresses associated with the user profile. In one instance, a website publisher 128 may provide the ad platform 114 with the IP address of a user interacting with its website as part of an advertisement placement request sent to the ad platform 114. The advertisement placement request could be sent either directly to the ad platform 114 or indirectly through a Real Time Bidding (“RTB”) Exchange 126 that allows online advertising to be purchased and served on the fly. Additional details of the interaction between RTB Exchange and the ad platform 114 is discussed in detail with reference to FIG. 4 and FIG. 5.

For the ad platform 114, the IP address serves as the “key” to identify personal computing devices that possibly all belong to the same user. The ad platform 114 may then utilize the user profile to provide various services across a given user's various personal computing devices. In one instance, the ad platform 114 could provide customized content, such as advertisements from advertisers 122, across the various personal computing devices of a given user, based on the user's profile. In one instance, a given user's profile could include information pertaining to the given user's interests and preferences. Such information could be gathered by the ad platform 114 utilizing various user-information gathering techniques well known in the art.

In some embodiments, the ad platform 114 could utilize the user data gathering techniques, which allow a third-party to provide a dynamic array of services and information to a user, as described in co-pending U.S. patent application Ser. No. 13/623,844 of A. Delug et al., filed on Sep. 20, 2012 and entitled, “Methods and Systems for MOBILE Ad Targeting,” (“The Hyper-targeting technique”), which is incorporated herein by reference, when choosing content to provide the mobile application running on the user's mobile device. For example, content such as display advertisements provided by the advertisers to publish within the mobile application, suggestions for new apps that the user might be interested in, etc. are based on information available through the user's mobile device.

In one embodiment, utilizing the hyper-targeting technique, the ad platform 114 determines the user's interests and preferences by using the information available through the user's mobile device 102. The ad platform 114 then stores the determined user's interests and preferences in a user profile associated with the user of the mobile device 102. In one instance, the information gathered through the user's mobile device could include the names, developer information, categories, etc. that are associated with the various software applications (“apps”) that are either installed on the mobile device or tagged as favorites by the user of the mobile device in, say, the app store. In one embodiment, the ad platform 114 utilizes the information regarding the various installed apps to determine the user's interest in, say, sports, business, any special interests, hobbies, etc.

For example, the ad platform 114 may determine the user to be a possible fishing enthusiast when the user has a number of installed apps that relate to fishing. Similarly, the ad platform 114 may determine the user to be a possible investor based on the various installed apps, such as stock trading apps and stock-market information apps, which the user utilizes on a regular basis. Such gathered information could be stored in a user profile associated with the user of the mobile device 102.

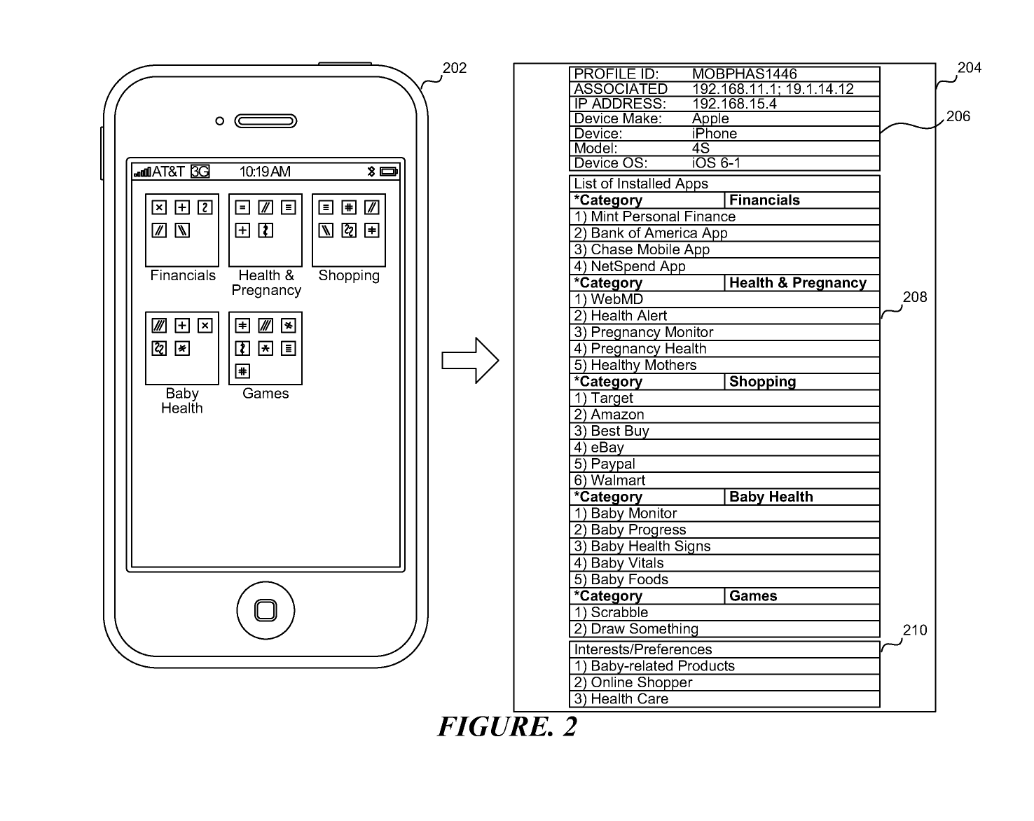

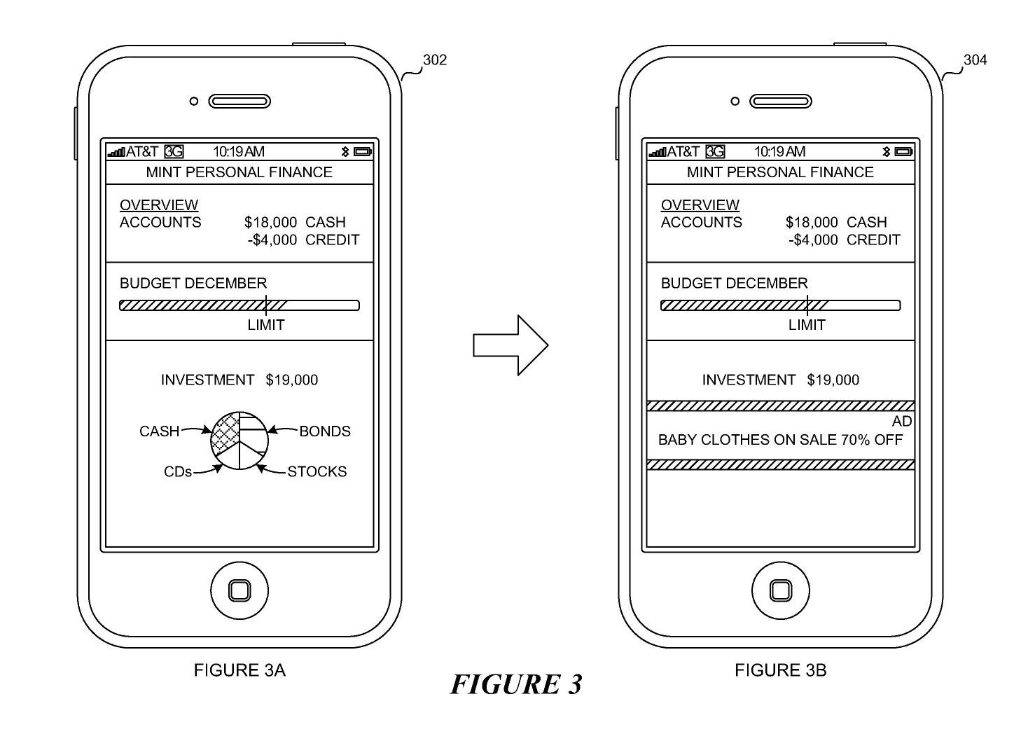

In one embodiment, utilizing the hyper-targeting technique, the ad platform 114 could gather the information available through the user's mobile device 102 for the user's profile by utilizing the appropriate APIs to request the mobile device to provide the requested information through the APIs. In another instance, the mobile device 102 may be authorized by the user of the mobile device to periodically send the relevant information to the ad platform 114. It should be noted that these suggested methods for gathering the information available through the personal computing devices are for illustrative purposes only and are not meant to limit the number of means for gathering the information available through the personal computing devices. Any method that is well-known in the art for gathering the information available through the personal computing devices could be utilized for the intended purpose. FIG. 2 and FIG. 3 provide an illustrative example of the hyper-targeting technique and the associated data gathering technique that could be utilized by the ad platform 114 to assemble the user profiles.

The ad platform 114 may then utilize the user's profile that includes the user's various preferences and interests, along with the various IP addresses associated with the user to provide a customized experience to the user across various personal computing devices, as long as the user's interaction originates from one of the IP addresses included in the user's profile. As discussed earlier, in one instance, a website publisher 128 may provide the ad platform 114 with the IP address of a user interacting with its website as part of an ad placement request sent to the ad platform 114.

The advertisement placement request could be sent either directly to the ad platform 114 or indirectly through a Real Time Bidding (“RTB”) Exchange 126 that allows online advertising to be purchased and served on the fly. So, by recognizing indirect user interactions through RTB Exchange 126, the ad platform 114 expands the content customization to not only those personal computing devices of the user that directly interacts with the ad platform 114 (e.g. a mobile phone with installed apps that are served ads directly by the ad platform 114), but also those personal computing devices that are limited to interacting with the ad platform 114 through RTB Exchange 126.

One illustrative example of an indirect interaction between the ad platform 114 and a user's computing device would be in the case of a user's desktop computer 104 that is to be provided with an ad to be displayed on one of the web pages, associated with the publishers 128, which is being shown in a web browser running on the desktop computer 104. Here, the desktop computer 104 transmits information, such as the desktop computer's configuration, screen size, IP information, etc., which are provided to the RTB Exchange 126 as part of the ad request by the publishers 128. The RTB Exchange 126 in turn shares the received information with the ad platform 114 (the intermediary for advertisers 122) and other advertisers 124 as part of the ad market place information. In the above scenario, the publishers 128 have web pages that include dedicated ad spaces in portions of the web pages served to a user. Such dedicated ad spaces constitute the publisher's 128 ad inventory.

In some embodiments, the publishers 128 could utilize the RTB Exchange 126 to market and sell their ad inventory, on the fly, in the ad market place to the highest bidder. The publishers 128 provide various details on the ad inventory to help the bidders for the ad inventory determine the suitability and value/price of the ad inventory for their content. The publishers' 128 provided information includes the information received from the user's personal computing device, e.g. a desktop computer 104, such as the size of the display screen, computing device's configuration, IP address associated with the computing device's network interactions with the publisher's content (including web pages), etc., and other information such as the size and location of the ad inventory on the publisher's content (e.g. top banner on a web site's home page of size 1020×100 pixels).

The RTB Exchange 126 in turn generates a bid request for the ad inventory from the publishers 128 with the publishers' 128 provided information and forwards the request to the various advertisers 124 and the ad platform 114. The advertisers 124 and the ad platform 114 analyze the suitability and value/price of the ad inventory for their content based on various parameters, including the publisher provided information included in the bid request. In one embodiment, the ad platform 114 compares the IP address included in the bid request against the various IP addresses stored in the user profiles gathered by the ad platform 114 as discussed earlier. When the ad platform 114 finds a match between the IP address included in the bid request and the IP address included in a user profile, there is a high possibility that the bid request for serving content (e.g. advertisements) to a user is for the same user associated with the user profile in the ad platform 114.

In some embodiments, when there is an IP address match, the ad platform 114 could utilize the user profile to further determine the suitability and value/price of the ad inventory for an advertiser's 122 content placed through the ad platform 114. Further, the user preferences and interests stored in the user profile could be utilized by the ad platform 114 to determine the suitability of content (e.g. advertisement) to be provided to the user. For example, a user reading financial news on a news website could be served with advertisements about baby products when the user profile shows a user interest in baby related information. Such an advertisement would have little in common with the context of the current user activities. In some embodiments, as advertisers are generally willing to pay a premium for displaying their advertisements to users who have shown a known preference for their advertised goods and services, the additional insight into the user preferences and interests allows the ad platform 114 to bid a higher amount than would be possible based solely on the information included in the bid request.

As discussed above, the ad platform 114 determines a value for the ad inventory and places a bid as a bid response with the ad platform 114 for the ad inventory. In some embodiments, the RTB Exchange 126 stops taking bids for the ad inventory after a fixed period of time expires from the time of the bid request and determines a highest bidder from the placed bids. In some embodiments, the RTB Exchange 126 provides the content (e.g. advertisement) included in the bid response of the highest bidder to the publisher for serving to the user. The publisher 128 then serves the highest bidder's content to the user in the ad space associated with the sold ad inventory. The highest bidder's content (e.g. advertisement) is forwarded to the user's personal computing device, where the content is served in the ad slot of a web page being hosted by the web browser on the user's personal computing device. Additional details of the interaction between RTB Exchange and the various advertisers 124, including the ad platform 114 that acts as an intermediary for advertisers 122, is discussed in detail with reference to FIG. 4 and FIG. 5.

FIG. 2 and FIG. 3 provide an illustrative example of the hyper-targeting technique and the associated data gathering technique that could be utilized by the ad platform 114 to assemble the user profiles. FIG. 2 illustrates a mobile device 202 with various applications and their associated application icons that are grouped under various categories respectively. The ad platform 114 may request the mobile device 202 to send a list of applications 208 that are installed on the mobile device through the network 112. FIG. 2 illustrates a list of installed applications 208 that might be received by the ad platform 114. In another instance, the ad platform 114 may determine the applications installed 208 on the mobile device by querying the mobile device for information that might help determine the installed applications.

The ad platform 114 may query the mobile device to provide information of applications listed in a given location of the user's mobile device, where the given location could include a home screen (i.e., desktop location) of the user's mobile device, the user's app store account, a favorites folder location in the user's mobile device, or a location maintaining a list of frequently executed applications. The ad platform 114 may also query the mobile device to provide usage information associated with the various identified apps, such as frequency of use of an app, date of last launch of an app, data bandwidth usage of an app, etc. In some embodiments, the ad platform 114 could store the received list of installed applications 208 and their associated usage information in a user profile 204.

The ad platform 114 could further store one or more IP addresses that are used by the mobile device 202 when communicating with the ad platform 114 in the user profile's 204 identity section 206. As discussed earlier, the IP addresses could serve as the “key” to identify a user. Further, the identity section 206 could include other information such as an alpha-numeric string as a profile ID and the system configuration information of the mobile device 202 (e.g. make, screen size, OS, etc. of the mobile device 202). In some embodiments, where the ad platform 114 interacts directly with the mobile device 202 (or any of the user's personal computing devices), the mobile device 202 could be required to include the profile ID in its communication with the ad platform 114, helping the ad platform 114 identify the user of the mobile device 202.

FIG. 3, sub FIGS. 3A and 3B illustrate advertisement targeting based on the user profile 204 gathered by the ad platform 114 in the case of direct communication (as discussed earlier) between a user's personal computing device and the ad platform 114. As discussed earlier, the ad platform 114 has determined and associated a user interest in “Baby-related Products” as part of the mobile user's user profile 204 based on the “Baby Health” apps utilized by the mobile user. The mobile user has five “Baby-related Products” related apps and therefore qualifies under the attributes associated with the “Baby-related Products” interests. In FIG. 3A, the mobile user is shown accessing the user's personal finances through a financial services related app called Mint. The Mint app is the currently active app being used by the mobile user. In some embodiments, when communicating directly with the mobile device 302, the ad platform 114 could identify the appropriate user profile to use in advertisement targeting by utilizing the profile ID provided by the user's mobile device 302 and matching the provided profile ID with that of a stored user profile.

In FIG. 3B, utilizing the identified user profile to use in conjunction with the user of the mobile device 304, the ad platform 114 serves the mobile user with advertisements related to baby clothes as a banner ad at the bottom of the mobile device screen. Here, the ad platform 114 relied at least in part on the user profile, which associated “Baby-related Products” with the mobile user when determining to serve the mobile user with advertisements for baby clothes. The ad platform 114 did not rely only on the contextual information of the currently active app to provide the advertisement. In this case, relying only on the contextual information of the currently active financial app would have generally prompted a financial products related advertisement. FIG. 2 and FIG. 3 provide an illustrative example of the hyper-targeting technique and the associated data-gathering technique utilized by the ad platform 114 in communication with a mobile device 202, 302. It should be noted here that the hyper-targeting technique and the associated data gathering technique can be utilized in conjunction with any of the user's personal communication devices that are directly communicating with the ad platform 114 and is not just limited to the mobile devices 202, 302 as shown in the illustrative example.

FIGS. 4 and 5 provide an illustrative example of how the ad platform 114 could identify a web user through the information provided by the RTB Exchange and apply hyper-targeting ad techniques to the ads served to the web user based on a user profile of the web user maintained by the ad platform 114. FIG. 4 provides an illustrative example of how a publisher's ad inventory (also referred to as an “impression”) is received and marketed by the RTB Exchange 420 to potential advertisers. In FIG. 4, a desktop computer 402 (i.e. a user's personal computing device) is shown displaying a publisher's webpage 406 (i.e. www.newyorktimes.com) to a user through a web browser 404 hosted on the desktop computer 402. The publisher's webpage 406 includes news articles and advertisements that are displayed in portions 408, 410 (marked as “advertisement inventory 1” 408 and “advertisement inventory 2” 410) of the webpage 406. Advertisement inventory 1 408 and advertisement inventory 2 410 each constitute a separate ad inventory (i.e. impression) for the webpage's 406 publisher, which can each be used to display an advertisement or other content to the user.

In one embodiment, when the user visits the publisher's webpage 406, the web browser 404 can send out a request 412 to the publisher's web server 416 for the contents of the publisher's webpage 406. In turn, the publisher's web server 416 could provide the web browser 404 with the requested information and request 414 the web browser 404 to provide information including those regarding the user and the personal computing device (i.e. desktop 402) hosting the web browser 404. The publisher requested information could include information associated with the user's desktop computer 402, such as the size of the display screen, its operating system, its capacity to run flash videos, its IP address, its internet connection provider, the nature of the internet connection (e.g. WiFi, LTE, etc.), the hosted web browser's make and version, and other user related information such as the possible gender of the user, the possible year of birth of the user, the possible area code within which the user's desktop computer 402 is being used from, etc.

In response to the publisher's request 414, the web browser 404 could gather the available requested information while complying with any privacy settings on the user's desktop computer and return 413 the requested information to the publisher's web server 416. For any information requested and not included by the web browser 404 in the response, the publisher's web server 416 could gather such information from other possible sources. For example, in the event that the IP address of the user is not included in the web browser's 404 response, the publisher's web server 416 could utilize the IP address associated with the response 413 received from web browser 404.

Once the publisher's web server 416 receives the response 413 from the web browser 404, the publisher's web server 416 sends 418 the gathered information and the information regarding each of the available ad inventories 408, 410 (such as the position and size of the advertisement on the webpage 406) to the RTB Exchange 420. As discussed earlier, the RTB Exchange 420 (i.e. a Real Time Bidding Exchange) allows online advertising to be purchased and served on the fly. In some embodiments, using the information received from the publisher's web server 416, the RTB Exchange 420 gathers additional information about the user that could help the advertisers better assess the value of the available ad inventories 408, 410. One source of additional information could be information from a third-party source, such as personal data aggregators, which was previously purchased by RTB Exchange 420.

In some embodiments, using the received and gathered information, the RTB Exchange 420 could generate a bid request for each of the available ad inventories 408, 410 and include the information in the bid request. The bid request could include multiple sections with each section including a plurality of fields. In some embodiments, the bid request could be formatted to comply with the openRTB Protocol, enabling any advertiser utilizing the openRTB Protocol to easily receive and process the bid request. It should be noted that the bid request could be in any format that could be received and processed by third-parties and that the openRTB Protocol is simply one of the many protocols that can be utilized by the RTB Exchange 420 when sending out a bid request.

In one embodiment, the RTB Exchange 420 generates bid requests 422, 423 with IDs “12446” and “13412” that correspond to “ad inventory 1” 408 and “ad inventory 2” 410, respectively. Here, the bid request 422 (also shown with the underlying details in 424), complying with the openRTB Protocol, could include information sections pertaining to the impression being sold 431, the publisher's website 432, the user's computing device 433, the user the ad is being shown to 434, etc. Further, the impression section 431 could include information such as the height, width and position of the impression, reference name for the impression 431a on the RTB Exchange 420, etc. The site section 432 could include information such as the name of the webpage where the impression is displayed, the domain of the webpage, a reference name of the site on the exchange, etc.

The device 433 section of the bid request 422 (detail view shown in 424) could include information pertaining to the user's computing device where the advertisement will be shown in. The device information could include the device ID 433a (e.g. the device's electronic serial number (“ESN”)), device platform ID 433b (e.g. UDID of iOS running devices), IP address 433c used by the device for network communication (e.g. IP address provided by the Internet service provider), the internet service provider 433d, etc. The user section 434 of the bid request 422 could include information pertaining to the user the impression is being served to. The user section 434 could include a unique consumer ID of the user on the exchange, year of birth of the user, gender of the user, zip code of the user, etc.

In some embodiments, the RTB Exchange 420 forwards the generated bid requests 422, 423 to various advertisers 426 and ad platforms 428 (that act as intermediaries for other advertisers 430). In some embodiments, the advertisers 426 and ad platforms 428 analyze the information included in the bid requests 422, 423 and return a bid response to the RTB Exchange 420 for each of the bid requests 422, 423 they are interested in. The bid responses include the bid amount each advertiser 426 (and ad platform 428) is willing to pay for the ad inventory associated with each of the bid requests 422, 423. Additional details of how the received bid request is processed and a bid generated for interested ad inventory is explained with reference to FIG. 5.

FIG. 5 provides an illustrative example of how the ad platform 526, 428 could identify a web user through the information provided by the RTB Exchange in the bid requests 422, 423 and apply the hyper-targeting ad techniques to the ads served to the web user, based on a user profile of the web user maintained by the ad platform 526, 428. As discussed with reference to FIG. 4, the ad platform 428, 526 receives bid requests 422, 423 from the RTB Exchange 420, 518. The ad platform 526 analyzes the received bid requests 422, 423 and identifies the ones it wants to bid for. In some embodiments, the ad platform 526 analyzes the received bid requests 422, 423 by first attempting to identify if any of the bid requests 422, 423 are for web users the ad platform 526 has a user profile for. As discussed in detail with reference to FIGS. 2 and 3, the ad platform 526 maintains user profiles of web users gathered as part of the hyper-targeting technique disclosed in co-pending U.S. patent application Ser. No. 13/623,844 of A. Delug et al., where such gathered user profiles of web users include various IP addresses associated with each of the web users.

In some embodiments, the ad platform 526 gathers the IP address included in the device section 433 of each received bid requests 422, 423 and compares it against the IP addresses stored in the profile section 206 of the various stored user profiles 204. In some embodiments, when the ad platform 526 finds a match between the IP address in the bid request 422, 423 and the IP address included in the user profile 204, the ad platform 526 utilizes the matched user profile to determine a bid amount and to choose the content (including advertisements) to be served in the event of a winning bid.

In one embodiment, when the ad platform 526 identifies more than one user profile 204 that includes a matching IP address, the ad platform 526 utilizes other information included in the bid request 422, 423, such as the web user's gender, zip, computing device's make, model, etc., and compares those against information included in each of the matched user profiles. In some embodiments, the ad platform 526 picks the user profile with the highest commonality in information with those included in the bid request 422, 423. In some embodiments, the ad platform 526 could assign different weight for each parameter, such as the web user's device's make and model carries a higher weight than the web user's gender, and picks the user profile with the highest information commonality score.

In some embodiments, when the ad platform 526 finds a match between the IP address in the bid request 422, 423 and the IP address included in the user profile 204, the ad platform 526 utilizes the matched user profile to determine a bid amount and to choose the content (including advertisements) to be served in the event of a winning bid. For example, if the user profile 204 shows the web user has shown a preference 210 for baby-related products, the ad platform 526 could choose to serve the web user with a baby-product related advertisement. Further, the ad platform 526 could determine the bid amount for the ad inventory (associated with a bid request 422, 423) based on the amount the advertisers of baby products are willing to pay.

For example, given that an advertiser marketing a baby product knows that the web user the advertisement is intended for has shown a preference for baby-related products, the advertiser might be willing to pay a higher premium for the ad inventory. The higher premium might be justified by the higher chances of converting the web user into an actual customer for the marketed product. Therefore, in some instances, by using the user profile gathered as part of the hyper-targeting technique, the ad platform 526 might be able to bid a higher amount than might be possible simply by using the web user's contextual information (such as the webpage and domain name) provided in the bid request 422, 423.

In one embodiment, the ad platform 526 might choose to provide a bid response 528 (also shown with underlying details in 534) to only a selected few bid requests 422, 423. As discussed earlier, the selection of which bid requests to respond to might be based on factors such as having a user profile for the web user (who the ads/content are intended for), advertiser interest in the web user, the location of the offered ad inventory, the number of different ads to serve a web user in a given page at a given time, etc. Here, for example, the ad platform 526 chooses to respond only to ad inventories associated with top banner inventories such as ad inventory 1 408, 508. So, the ad platform 526 generates a bid response to the bid request 422 that corresponds to the ad inventory 1 408, 508.

In some embodiments, the bid response 528 (shown in detailed view in 534) could include multiple sections with each section including a plurality of fields. In some embodiments, the bid response 528 could be formatted to comply with the openRTB Protocol, enabling the RTB Exchange 518 to easily receive and process the bid response 528. It should be noted that the bid response could be in any format that could be received and processed by the RTB Exchange 518 and that the openRTB Protocol is simply one of the many protocols that can be utilized by the ad platform 526 when sending out a bid response 528 (also shown with underlying details in 534).

In one embodiment, the RTB Exchange 518 generates bid requests 528, (also shown with underlying details in 534) with ID “12446” 534a that correspond to the bid request 422 and BIDID “2412” 534b that identifies the ad platform 526 as the bidder. Here, the bid response 528 (also shown with the underlying details in 534), complying with the openRTB Protocol, could include additional information such as the impression's ID in the exchange 534c, the bid amount for that impression 534d, the ID of the advertisement 534e (already stored and served from the RTB Exchange 518) to be served if bid won, etc., which pertain to the placed bid.

In one embodiment, the ad platform 526 forwards 524 the bid response 528 to the RTB Exchange 518. Further, the RTB Exchange 518 receives 536 other bid responses 532, 522 from other advertisers 530 who are interested in the ad inventory 508 associated with ID “12446” (that correspond to the bid request 422). In one embodiment, after a fixed time has lapsed after sending the bid request 422, the ad platform 526 stops taking additional bid responses for the ad inventory 508 associated with ID “12446” and chooses one of the received bid responses as the winning bidder for the ad inventory 508. In one embodiment, the ad platform 526 chooses the winning bidder based on the bid amount, with the highest bidder winning the bid. Here, of the two received bid responses 520, 522 for ad inventory 1 508, the ad platform's 526 bid response 528 has the higher bid amount at $1.45 (compared to $1 bid amount from bid response 522, 532).

In one embodiment, the ad platform 526 retrieves an advertisement with “adid” 534e “A424” (included in the winning bid response 520, 528, 534) from its advertisement database and forwards 516 the advertisement to the publisher server 514. In some embodiments, the publisher server 514 in turn forwards 512 the received advertisement to the web browser 504 running on the user's desktop computer 502 along with the indicator for which ad inventory to serve the received advertisement in. In one embodiment, the web browser 504 identifies and displays the received advertisement in the ad inventory #1 508 of webpage “www.newyorktimes.com” 506. The ad inventory 2 510 on the webpage 506 is served with other advertisements received by the web browser 504 from the publisher server 514.

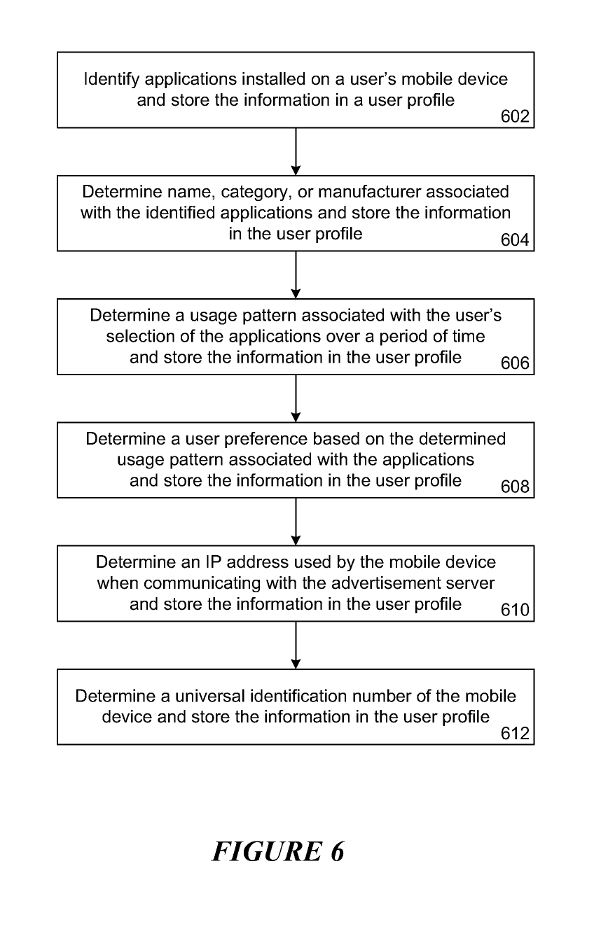

FIG. 6 is a flow chart illustrating user profile gathering (discussed in conjunction with FIG. 2) that is used in “hyper-targeting” techniques. In step 602, the advertisement server 116 identifies applications installed on a user's computing device (such as a mobile device). In one instance, the advertisement server 116 queries the mobile device to provide the list of applications executed within a two-month period and receives, from the mobile device, the applications installed on the mobile device. In step 604, the ad platform 114 determines a name, category, or manufacturer associated with each of the applications identified in step 602 and stores the information along with the identified applications in a user profile associated with the mobile user. In one instance, the ad platform 114 could query the mobile device for meta-data associated with each application and parse the received meta-data to identify the pertinent information associated with each application.

In step 606, the ad platform 114 determines a usage pattern for each of the identified applications and stores the usage pattern in the user profile associated with the mobile user. In one instance, the usage pattern could be based on usage information of the application. The ad platform 114 queries the mobile device again to request usage information associated with each of the identified applications. The usage information could include frequency of use of each application, the last date of use/launch of an application, the data bandwidth consumption of each application, etc. In one instance, the advertisement server could bucket the various applications based on their usage patterns, such as light use, regular use, heavy use, etc., where the degree of use is based on a function of the various usage information parameters such as frequency of use of each application, the last date of use/launch of an application, the data bandwidth consumption of each application, etc.

In step 608, the ad platform 114 determines various user preferences for the mobile user based on the determined usage pattern associated with the applications and stores the user preferences in the user profile associated with the mobile user. For example, if the user has at least five games in the combined regular and heavy use categories, then a user preference of “Hardcore Games” can be associated with the mobile user. Similarly, if the user has at least one app related to babies in their heavy use category, then an additional user preference of “Baby-related Products” can be associated with the mobile user.

In step 610, the ad platform 114 determines the IP address used by the mobile device when communicating with the ad platform 114. If the determined IP address falls within the class of private IP addresses, the ad platform 114 stores the IP address in the user profile associated with the mobile user.

In step 612, the ad platform 114 queries the mobile device to provide its universal identification number, such as its electronic serial number (“ESN”) and stores the received identification number in the user profile associated with the mobile user. The universal identification number, such as ESN, is unique to each mobile device. By matching the ESN in the user profile with that of the ESN of the mobile device communicating with the ad platform 114, the server 116 could identify the user profile associated with the mobile user.

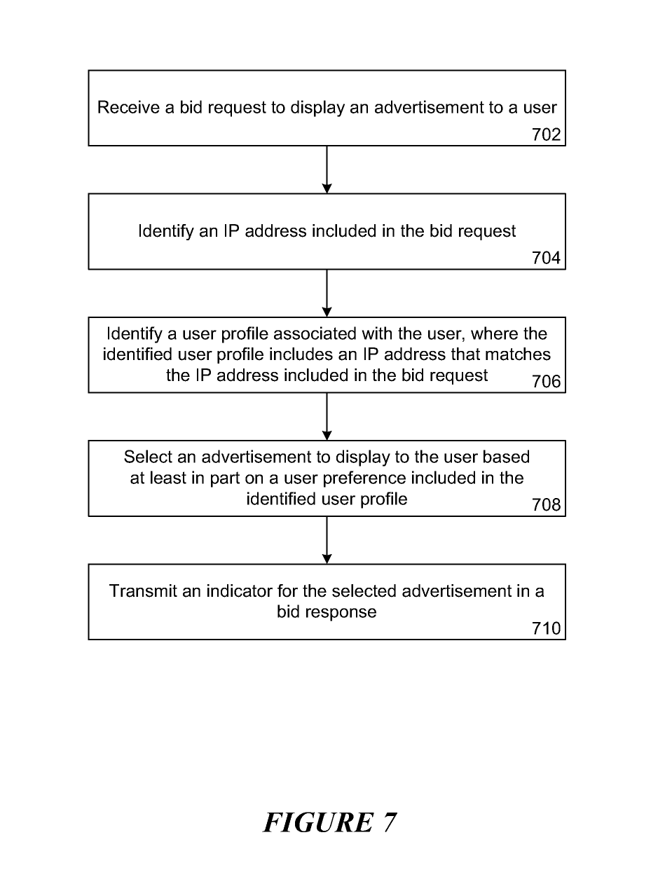

FIG. 7 is a flow chart illustrating how the information included in a bid request from a RTB Exchange 126 could be used to identify a user profile of an internet user and use the identified user profile to provide targeted advertisements to the internet user. In step 702, the ad platform 114 receives a bid request 424 to display an advertisement to a web user in an advertising section of a webpage. In step 704, the ad platform 114 identifies an IP address 433c included in the bid request 424. In step 706, the ad platform 114 identifies a user profile 204 associated with the web user, where the identified user profile 206 includes an IP address that matches the IP address 433c included in the bid request 424. In step 708, the ad platform 114 selects advertisements for the web user utilizing the user preferences 210 and other information 208, such as determined name, category, or manufacturer associated with the identified applications (determined in step 604), included in the user profile 204. For example, if the user preference 210 in the user profile 204 includes “Baby-related Products,” then advertisements from J n′ J (a baby products vendor) can be displayed to the web user. In step 710, the ad platform 114 transmits an indicator of the selected advertisement 534e in a bid response 534 to the RTB Exchange 126, 518, which then transmits the advertisement associated with the indicator 534e to the publisher of the webpage if the bid response 534 had the highest bid amount 534d. The publisher of the webpage transmits the received advertisement to the web user's web browser, which then displays the received advertisement to the web user.

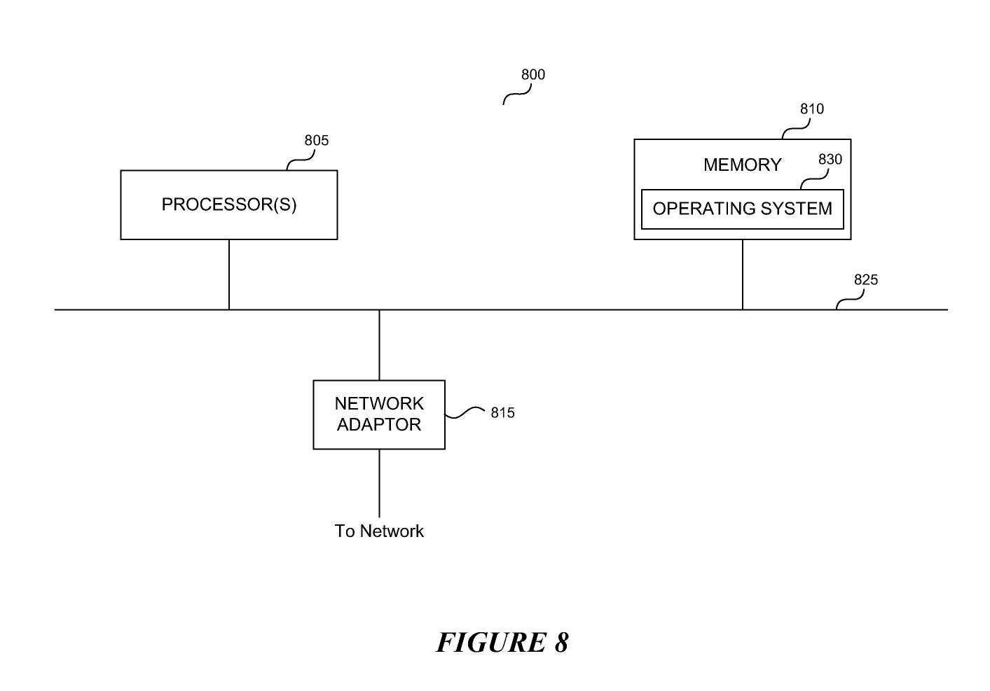

FIG. 8 is a high-level block diagram showing an example of the architecture for a computer system 800 that can be utilized to implement an advertisement server (e.g., 116 from FIG. 1), a web server (e.g., 120 from FIG. 1), etc. In FIG. 8, the computer system 800 includes one or more processors 805 and memory 810 connected via an interconnect 825. The interconnect 825 is an abstraction that represents any one or more separate physical buses, point to point connections, or both connected by appropriate bridges, adapters, or controllers. The interconnect 825, therefore, may include, for example, a system bus, a Peripheral Component Interconnect (PCI) bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 894 bus, sometimes referred to as “Firewire.”

The processor(s) 805 may include central processing units (CPUs) to control the overall operation of, for example, the host computer. In certain embodiments, the processor(s) 805 accomplish this by executing software or firmware stored in memory 810. The processor(s) 805 may be, or may include, one or more programmable general-purpose or special-purpose microprocessors, digital signal processors (DSPs), programmable controllers, application-specific integrated circuits (ASICs), programmable logic devices (PLDs), or the like, or a combination of such devices.

The memory 810 is or includes the main memory of the computer system 800. The memory 810 represents any form of random access memory (RAM), read-only memory (ROM), flash memory, or the like, or a combination of such devices. In use, the memory 810 may contain, among other things, an operating system 830 and a set of machine instructions which, when executed by processor 805, causes the processor 805 to perform operations to implement embodiments of the present invention.

Also connected to the processor(s) 805 through the interconnect 825 is a network adapter 815. The network adapter 815 provides the computer system 800 with the ability to communicate with remote devices, such as the storage clients, and/or other storage servers, and may be, for example, an Ethernet adapter or Fiber Channel adapter.

Unless the context clearly requires otherwise, throughout the description and the claims, the words “comprise,” “comprising,” and the like are to be construed in an inclusive sense (i.e., to say, in the sense of “including, but not limited to”), as opposed to an exclusive or exhaustive sense. As used herein, the terms “connected,” “coupled,” or any variant thereof means any connection or coupling, either direct or indirect, between two or more elements. Such a coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above Detailed Description of examples of the invention is not intended to be exhaustive or to limit the invention to the precise form disclosed above. While specific examples for the invention are described above for illustrative purposes, various equivalent modifications are possible within the scope of the invention, as those skilled in the relevant art will recognize. While processes or blocks are presented in a given order in this application, alternative implementations may perform routines having steps performed in a different order, or employ systems having blocks in a different order. Some processes or blocks may be deleted, moved, added, subdivided, combined, and/or modified to provide alternative or sub-combinations. Also, while processes or blocks are at times shown as being performed in series, these processes or blocks may instead be performed or implemented in parallel, or may be performed at different times. Further, any specific numbers noted herein are only examples. It is understood that alternative implementations may employ differing values or ranges.

The various illustrations and teachings provided herein can also be applied to systems other than the system described above. The elements and acts of the various examples described above can be combined to provide further implementations of the invention.

Any patents and applications and other references noted above, including any that may be listed in accompanying filing papers, are incorporated herein by reference. Aspects of the invention can be modified, if necessary, to employ the systems, functions, and concepts included in such references to provide further implementations of the invention.

These and other changes can be made to the invention in light of the above Detailed Description. While the above description describes certain examples of the invention, and describes the best mode contemplated, no matter how detailed the above appears in text, the invention can be practiced in many ways. Details of the system may vary considerably in its specific implementation, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

While certain aspects of the invention are presented below in certain claim forms, the applicant contemplates the various aspects of the invention in any number of claim forms. For example, while only one aspect of the invention is recited as a means-plus-function claim under 35 U.S.C. §112, sixth paragraph, other aspects may likewise be embodied as a means-plus-function claim, or in other forms, such as being embodied in a computer-readable medium. (Any claims intended to be treated under 35 U.S.C. §112, ¶ 7 will begin with the words “means for.”) Accordingly, the applicant reserves the right to add additional claims after filing the application to pursue such additional claim forms for other aspects of the invention.

1. A method, comprising:
receiving, by an advertising server having a memory component for storing computer-executable instructions and a processor for accessing the memory component and for performing the method, a bid request to display an advertisement to a user in an advertising section of a webpage, the bid request including an internet protocol (“IP”) address associated with the user;
identifying, by the advertising server, a user profile associated with the user, wherein the identified user profile includes at least one IP address that matches the IP address included in the bid request;
determining, by the advertising server, an advertisement to display to the user, the determination based at least in part on a user preference included in the user profile.

2. The method of claim 1, wherein the user profile associated with the user is gathered from a computing device associated with the user, the step of gathering the user profile includes determining an IP address included in a communication from the computing device and storing the determined IP address in the user profile.

3. The method of claim 2, wherein a given IP address is stored in a given user profile only if the given IP address belongs to a specific class of IP addresses.

4. The method of claim 3, wherein the specific class of IP addresses includes the private IP address class.

5. The method of claim 2, wherein a plurality of computing devices are associated with the user, each of the plurality of computing devices communicating at least once utilizing the IP address.

6. The method of claim 2, wherein the step of gathering the user profile further comprises:
determining information associated with one or more applications installed on the computing device of the user, the determined information including one or more of a name, category, or a manufacturer associated with the one or more applications;
determining a usage pattern associated with the user's selection of the one or more applications over a period of time;
determining a user preference based at least in part on the determined usage pattern associated with the one or more applications; and
storing the determined user preference, the usage pattern and the information associated with the one or more applications in the user profile.

7. The method of claim 6, wherein the identified one or more applications includes an application installed in a given location of the computing device of the user, the given location including one or more of a desktop location of the user's computing device, the entire user's computing device, a favorites folder location in the user's computing device, or a location maintaining a list of frequently executed applications.

8. The method of claim 1, further comprising:
determining, by the advertising server, a bid amount to include in a bid response, wherein the bid amount is the maximum amount offered for the display of the advertisement in the advertising section of the webpage;
generating, by the advertising server, the bid response for the display of the advertisement, the bid response including the bid amount and an indicator associated with the advertisement.

9. The method of claim 8, wherein the bid request includes one or more of:
an indicator associated with the advertising section of the webpage;
a model name of a computing device utilized to display the advertisement;
a name of an operating system running on the computing device;
a name of the webpage;
a universal device identification number associated with the computing device; or
a name of a provider of internet services to the computing device.

10. A method, comprising:
accessing, by a computing device having a memory component for storing computer-executable instructions and a processor for accessing the memory component and for performing the method, a webpage by a user through the computing device, the webpage including an advertising section for display of a given advertisement in the webpage;
sending, by the computing device, information for a bid request for display of an advertisement in the advertising section of the webpage, the information sent as a communication over a network, the communication including an internet protocol (“IP”) address associated with the computing device;
receiving, by the computing device, the advertisement to display to the user in the advertising section of the webpage, the received advertisement determined at least in part on a user preference included a user profile, the user profile being associated with the user, wherein the user profile of the user includes at least one IP address that matches the IP address included in the communication.

11. The method of claim 10, wherein the user profile associated with the user is gathered from a second computing device associated with the user, the step of gathering the user profile includes determining a second IP address included in a second communication from the second computing device and storing the determined second IP address in the user profile.

12. The method of claim 11, wherein a given IP address is stored in a given user profile only if the given IP address belongs to a specific class of IP addresses.

13. The method of claim 12, wherein the specific class of IP addresses includes the private IP address class.

14. The method of claim 11, wherein the step of gathering the user profile further comprises:
determining information associated with one or more applications installed on the second computing device of the user, the determined information including one or more of a name, category, or a manufacturer associated with the one or more applications;
determining a usage pattern associated with the user's selection of the one or more applications over a period of time;
determining a user preference based at least in part on the determined usage pattern associated with the one or more applications; and
storing the determined user preference, the usage pattern and the information associated with the one or more applications in the user profile.

15. The method of claim 14, wherein the identified one or more applications includes an application installed in a given location of the computing device of the user, the given location including one or more of a desktop location of the user's computing device, the entire user's computing device, a favorites folder location in the user's computing device, or a location maintaining a list of frequently executed applications.

16. The method of claim 10, wherein the sent information includes one or more of:
an indicator associated with the advertising section of the webpage;
a model name of the computing device utilized to display the advertisement;
a name of an operating system running on the computing device;
a name of the webpage;
a universal device identification number associated with the computing device; or
a name of a provider of internet services to the computing device.

17. A system, comprising:
at least one memory storing computer-executable instructions; and
at least one processor configured to access the at least one memory and execute the computer-executable instructions to perform a set of acts, the acts including:
receiving a bid request to display an advertisement to a user in an advertising section of a webpage, the bid request including an inter protocol (“IP”) address associated with the user;
identifying a user profile associated with the user, wherein the identified user profile includes at least one IP address that matches the IP address included in the bid request;
determining an advertisement to display to the user, the determination based at least in part on a user preference included the user profile.

18. The system of claim 17, wherein the user profile associated with the user is gathered from a computing device associated with the user, the step of gathering the user profile includes determining an IP address included in a communication from the computing device and storing the determined IP address in the user profile.

19. The system of claim 18, wherein a given IP address is stored in a given user profile only if the given IP address belongs to a specific class of IP addresses.

20. The system of claim 19, wherein the specific class of IP addresses includes the private IP address class.

21. The system of claim 18, wherein a plurality of computing devices are associated with the user, each of the plurality of computing devices communicating at least once utilizing the IP address.

22. The system of claim 18, wherein the step of gathering the user profile further comprises:
determining information associated with one or more applications installed on the computing device of the user, the determined information including one or more of a name, category, or a manufacturer associated with the one or more applications;
determining a usage pattern associated with the user's selection of the one or more applications over a period of time;
determining a user preference based at least in part on the determined usage pattern associated with the one or more applications; and
storing the determined user preference, the usage pattern and the information associated with the one or more applications in the user profile.

23. The system of claim 22, wherein the identified one or more applications includes an application installed in a given location of the computing device of the user, the given location including one or more of a desktop location of the user's computing device, the entire user's computing device, a favorites folder location in the user's computing device, or a location maintaining a list of frequently executed applications.

24. The system of claim 17, wherein the acts further includes:
determining a bid amount to include in a bid response, wherein the bid amount is the maximum amount offered for the display of the advertisement in the advertising section of the webpage;
generating the bid response for the display of the advertisement, the bid response including the bid amount and an indicator associated with the advertisement.

25. The system of claim 17, wherein the bid request includes one or more of:
an indicator associated with the advertising section of the webpage;
a model name of a computing device utilized to display the advertisement;
a name of an operating system running on the computing device;
a name of the webpage;
a universal device identification number associated with the computing device; or
a name of a provider of internet services to the computing device.

26. A system, comprising:
a means for receiving a bid request to display an advertisement to a user in an advertising section of a webpage, the bid request including an inter protocol (“IP”) address associated with the user;
a means for identifying a user profile associated with the user, wherein the identified user profile includes at least one IP address that matches the IP address included in the bid request;
a means for determining an advertisement to display to the user, the determination based at least in part on a user preference included the user profile.

27. The system of claim 26, wherein the user profile associated with the user is gathered from a computing device associated with the user, the step of gathering the user profile includes determining an IP address included in a communication from the computing device and storing the determined IP address in the user profile.

28. The system of claim 27, wherein a given IP address is stored in a given user profile only if the given IP address belongs to a specific class of IP addresses.

29. The system of claim 27, wherein a plurality of computing devices are associated with the user, each of the plurality of computing devices communicating at least once utilizing the IP address.

30. The system of claim 27, wherein for the step of gathering the user profile, the system further comprises:
means for determining information associated with one or more applications installed on the computing device of the user, the determined information including one or more of a name, category, or a manufacturer associated with the one or more applications;
means for determining a usage pattern associated with the user's selection of the one or more applications over a period of time;
means for determining a user preference based at least in part on the determined usage pattern associated with the one or more applications; and
means for storing the determined user preference, the usage pattern and the information associated with the one or more applications in the user profile.
